(19) United States
(12) Patent Application Publication
(10) Pub. No.: US 2016/0095290 A1
(43) Pub. Date: Apr. 7, 2016

(54) Animal Carrier For Vehicles

(71) Applicant: Frank Reginhard, Gurgaon (IN)

(72) Inventor: Frank Reginhard, Gurgaon (IN)

(21) Appl. No.: 14/968,575

(22) Filed: Dec. 14, 2015

Related U.S. Application Data
(63) Continuation-in-part of application No. 14/019,690, filed on Sep. 6, 2013, now Pat. No. 9,247,711.

(30) Foreign Application Priority Data
Jun. 4, 2013 (IN) 1674/DEL/2013

(51) Int. Cl. A01K 1/00; A01K 1/02; B64D 9/00; B01D 46/00

(52) U.S. Cl. CPC A01K 1/0035; B01D 46/0038; A01K 1/0236; B64D 9/003

(57) ABSTRACT

An animal carrier (100) has a container (101) with vertical side-walls (102) and ground-plate (114) and a frame (107) that holds the vertical side-walls (102) and the ground plate (114). The frame (107) is moulded from composite material. A first connector (151) inside the container (101) is located between the vertical side-walls (102) and receives at least one cage (131) for holding an animal (141). A second connector (152) is attached to the ground-plate (114) at the outside of the container (101) and connects the container (101) to floor-tracks (162) in the passenger cabin (161) of a vehicle so that the container (101) is secured against displacement.

### CROSS-REFERENCE TO RELATED APPLICATIONS

This is a continuation in part application which claims priority to U.S. Ser. No. 14/019,690, filed Sep. 6, 2013, entitled “Animal Carrier for Transporting Animals Onboard a Vehicle”, which claims foreign priority to IN 1674/DEL/2013 filed Jun. 4, 2013. All of the above applications are hereby incorporated by reference in their entirety.

### TECHNICAL FIELD

The description relates to animal carriers, and more particularly relates to animal carriers that may be transported on board the passenger cabin of a vehicle such as an aircraft or a train.

### BACKGROUND

When travelling, people turn into passengers of a vehicle. The vehicle can be a car, a bus, a railway train, an aircraft, a helicopter, a hovercraft, a ship, a boat, a ferry, ropeway or any other means for transportation.

Some passengers carry luggage, or baggage. Transporting luggage in a vehicle could be dangerous, especially when the vehicle starts or stops to move. As a consequence, most vehicles are specially equipped to store luggage in dedicated sections. For example, the car or railway passenger places luggage in luggage compartments of cars and trains; air passengers use overhead bins for carry-on luggage, but the passengers need to hand over larger luggage to the operator of the aircraft. The operator stores it in cargo sections. Other examples could be cited, but a general approach to separate the passenger from the luggage is visible.

Some passengers also travel together with animals. The animals can be pet animals, such as cats, dogs, rabbits, ferrets, birds etc. Sometimes, animals can travel alone, in the sense that the person usually looking after the animal is not the passenger. In such cases, the animal is looked after during the trip by a different person, for example, by airline staff. Animals—especially pets—have travel or transportation requirements that are usually different from the requirements of the passenger.

A traditional approach to address the requirement is the use of cages, or boxes, or kennels. One or more animal is placed inside a cage. The cage is carried by the passenger. A further traditional approach is to treat the animals as luggage. With or without cage, the animal can be placed into the cargo section of the vehicle.

But both traditional approaches cause inconvenience for passengers (for the passenger attending the animal as well as for other passengers), and for the animal itself. There is always a variety of conflicts that result from the separation of the animal from the passenger during travel and from animal specific requirements that appear incompatible with the requirements of the passengers.

### SUMMARY

According to embodiments of the present invention, a transportation system is provided that addresses animal-specific requirements and aircraft-specific requirements. The core of the system is an animal carrier (or animal pod) that has two connectors (or interfaces): A first connector, the cage-connector, is adapted to receive cages with animals; and a second connector, the track-connector, establishes a connection to floor-tracks that are available in passenger aircraft and trains which are designed to hold the passenger seats.

### BRIEF DESCRIPTION OF THE DRAWINGS

FIG. 1 illustrates an overview of a transportation system with a passenger cabin of a vehicle, an animal carrier, and a passenger seat;

FIGS. 2A, 2B illustrate perspective views of the animal carrier;

FIG. 2C illustrates details of the inside of the animal carrier;

FIG. 2D illustrates a side view of the animal carrier;

FIG. 2E illustrates a side view of the animal carrier with a focus on a frame;

FIG. 3 illustrates a partial view of the animal carrier mounted in the floor-tracks of an aircraft;

### DETAILED DESCRIPTION OF THE DRAWINGS

To illustrate the embodiments of the transportation system with the animal carrier, the description identifies some exemplary animal-specific requirements that are related to an animal being transported in vehicles. The requirements are particularly applicable to pet animals.

Before describing the invention in detail, it should be observed that the present invention utilizes apparatus components related to the transportation of animals on board a vehicle. Accordingly the apparatus components have been represented where appropriate by conventional symbols in the drawings showing only specific details that are pertinent for an understanding of the present invention so as not to obscure the disclosure with details that will be readily apparent to those with ordinary skill in the art having the benefit of the description herein.

While the specification concludes with the claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

(1) The animal may need communication with the passenger. The passenger wishes to monitor the animal all of the time during travel. The animal itself (especially a cat or a dog) needs to feel the presence of the passenger. The communication is not only for the benefit of the animal. It is noted that, for example, a guide dog provides assistance for visually impaired passengers.

(2) The animal may need to be kept in physical distance from other animals, or from other persons inside the vehicle. There are many underlying reasons for this requirement: animals might attack each other, or an animal might interfere with other passengers.

(3) At any time during travel, and at any location inside the vehicle, the animal may produce excrements, odours or noise that may causes irritation to other passengers. There is a requirement to keep the irritations at minimum.

(4) For some animals—especially for animals of high monetary or idealistic value—the life support standard should be the same standard that is applicable for passengers. For example, in the event that the cabin pressure drops, aircraft passengers receive oxygen supply, and in such events, oxygen would have to be supplied to the animal as well.

(5) Animals may have different sizes or physical dimensions, and the number of animals to be transported at the same time may vary. A passenger can accompany one or more animals.

(6) An animal may be sensible to ambient conditions, such as air temperature, air pressure, light or darkness, and vehicle vibrations. Changes of such conditions are important as well. In extreme situations, the animal might be physically injured, psychological distressed, or might even die. For example, putting a sensitive cat into the darkness of a shaking cargo bay might be distressing. It should be noted that animals react to ambient conditions differently than humans.

(7) An animal might need food, water or even medicine, especially in case of long distance travelling. In case of delays, travel time can exceed the schedule.

(8) The animal takes away space that is dedicated for the passenger. Or, in aircraft or train, the animal might be placed beneath the front seat, with or without cage. This results in decreased leg room for the passenger. The space should therefore be used as efficiently as possible.

Discomfort can arise from non-compliance with the requirements, and the discomfort could extend to: both the passenger and the animal, the passenger and the operator of the vehicle, to the operator of the vehicle, to other passengers and so on. It is noted that animal-specific requirements can be further distinguished and that not all requirements are applicable for a particular animal. For example, the above-mentioned guide is specially trained and even does not need a cage.

Some events can lead to non-compliance with multiple requirements at the same time.

There are also vehicle-specific requirements. For simplicity, the description concentrates on requirements that are specific for aircraft but a person of skill in the art can map these requirements to other vehicles, such as trains or cars.

In aircraft, the equipment inside the cabin (i.e. seats, and overhead-luggage bins, toilet equipment, and the animal carrier itself) has to be manufactured by a material that has low flammability (in terms of the ability to ignite, to generate smoke and toxic gases), relatively low weight (in terms of using the materials in vehicles), relatively high strength, durable cosmetics (to retain colour etc. over time). Also, the material must allow efficient processing during manufacturing of the equipment.

The vehicle-specific requirements include safety requirements (e.g., fire resistance of the carrier) and security requirements. Equipment to be used in aircraft—for example, the carrier and the cage—is subject to tests according to standards set by authorities. The authorities include, for example, appropriate federal authorities for example the FAA (Federal Aviation Administration) in the United States, the DGCA (Directorate General of Civil Aviation) in India, the EASA (European Aviation Safety Agency) in the European Union, and others.

For materials, such requirements are often summarized under the acronym FST standing for Fire, Smoke, and Toxicity.

The authorities specify small-scale reaction-to-fire tests and full-scale aircraft cabin fire tests. To delay the occurrence of non-survivable conditions (such as cabin flashover) and to increase the escape time for passengers, the tests specify maximum smoke and heat release values for large-area materials. Modern aircraft, especially large aircraft use more and more combustible, lightweight organic materials. But to comply with cabin and airframe fire loads that are currently specified by the tests, these materials need significant reductions in flammability.

Further, vehicle-specific requirements can include limitations to the overall weight (carrier, cage and animal).

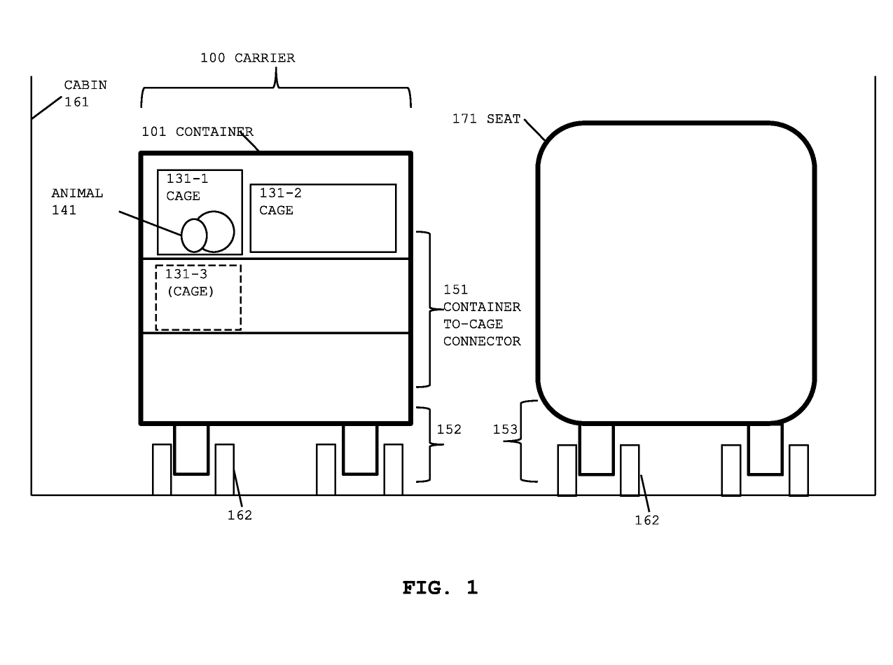

FIG. 1 illustrates an overview of a transportation system with passenger cabin 161 of a vehicle, animal carrier 100, and passenger seat 171. The underlying general principle is a hierarchy of transport containers that enclose further transport containers, or the animal itself.

As illustrated at the left side of the figure, cage 131 encloses animal 141. Animal carrier 100 has container 101 that encloses cage 131. Cage 131 collectively stands for a number of separate cages 131-1, 131-2, 131-3 etc. that can individually be present or absent. Passenger cabin 161 encloses animal carrier 100, and the vehicle can be regarded to enclose passenger cabin 161. As illustrated at the right side of the figure, passenger seat 171 can be provided as well. Passenger cabin 161 is an integral part of the vehicle.

Animal carrier 100 is usually inserted into passenger cabin 161 when the vehicle is prepared for being used. For example, if the operator of an airline receives the information that some passengers may be accompanied by animals, the operator may insert animal carrier 100 into passenger cabin 161. Inserting animal carrier 100 is similar to inserting passenger seat 171. It should be noted that these days both in aircraft and train there are configurations where there are not independent seats, so one whole row of seats may be removed to accommodate the Animal Carrier 100. That way the Animal Carrier 100 can carry more than one animal.

Cage 131 is inserted into animal carrier 100 when a particular passenger travels, usually upon boarding the vehicle (i.e. boarding the passenger cabin). Cage 131 removed from animal carrier 100 when the passenger ends his/her journey and leaves the aircraft. In other words, the passenger can transport cage 131 by hand until he/she gets seated (for example on seat 171). In this scenario, cage 131 is not a piece of luggage. Animal carrier 100 provides for compliance with the above identified animal specific requirements.

As it will be shown with more detail below, animal carrier 100 has fastening means to allow the passenger to secure cage 131 in a position that is properly restrained in compliance with the requirements, especially with the vehicle-specific safety requirements. The passenger does not have to be a technician. Securing cage 131 is as easy as fastening a seat belt. Tools are not required. Tools are not available to passengers anyway.

It should be noted that the person transporting cage 131 to/from animal carrier 100 must not be the passenger, the person could be a crew member or other support staff. Animal 141 is located inside cage 131 so that the person is protected (against the animal). It could also be contemplated that cage 131 is transported by a robot.

Cage 131 can contain one or more animals, but it is also possible that a cage remains empty. As illustrated in the figure, cage 131-2 is illustrated as an empty cage, i.e. a cage without an animal. In other words, animal carrier 100 is designed for carrying multiple animals, and complies with the above-mentioned animal-specific requirements.

Using cages (that are separate from the carrier) may be advantageous for inspection routines at airports. The inspection can include check-in inspections (or departure inspections), security inspections, veterinarian inspections and the like. The animal goes through the inspection inside cage 131, but animal carrier 100 is already in the aircraft. There is no need to inspect animal carrier 100. Additional equipment at animal carrier 100 (such as life-support equipment, fans, lights, food supply) would not disturb the inspection. There is no need to change the cages at departure and at destination as the animal stays inside the same cage during the entire journey. It should be noted that a cage is less expensive to manufacture than the carrier.

Further, the departure inspection can identify properties of the animal (optionally, of the cage), so that property data can be forwarded to the aircraft, or can be used to adjust requirements. For example, the body weight of the animal can be measured so that a corresponding fare can be calculated. Transporting a heavy-weight animal might be more expensive that transporting a light-weight animal. The weight to be considered for calculating the fare can include the weight of the cage. Weight-specific fares usually restricted to luggage, and at least current not available to the passengers. It should be noted that measuring the weight of the animal inside the cage is much easier to accomplish than to establish the weight if placed inside the carrier. Further, the other method to determine the fare might be by using the dimensions of the cage. The dimension of cage would also help in determining the position of the cage inside carrier 100 meaning how a cage of particular dimension would be placed inside the carrier 100.

Looking at the connectors 151, 152, there is cage-connector 151 (of the first type) between cage 131 and container 101, and there is track-connector 152 (of the second type) between container 101 and passenger cabin 161. Looking at container 101 of animal carrier 100, container 101 has connector 151 to the cage, and has connector 152 to passenger cabin 161.

To meet the above-introduced requirements, container 101 and connectors 151, 152 are provided by the following structural elements:

(a) Connector 151 of animal carrier 100 is implemented in such a way that carrier 100 remains stable even if no cage is inserted. This is especially convenient in aircraft, the operator of the aircraft does not have to differentiate between empty and occupied carriers. In other words, the carrier has a solid structure.

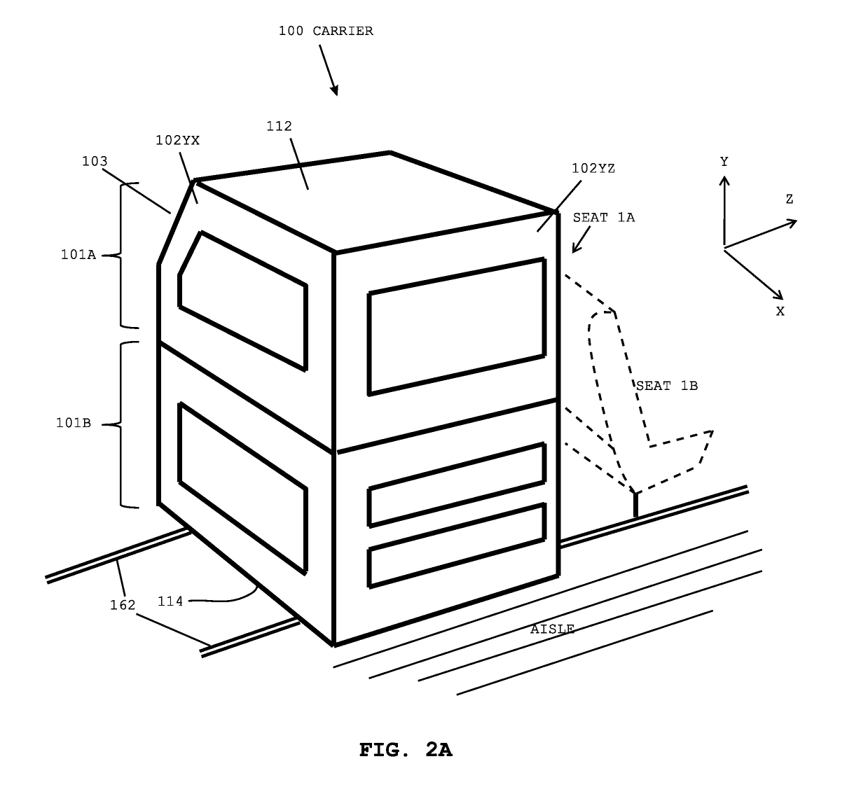

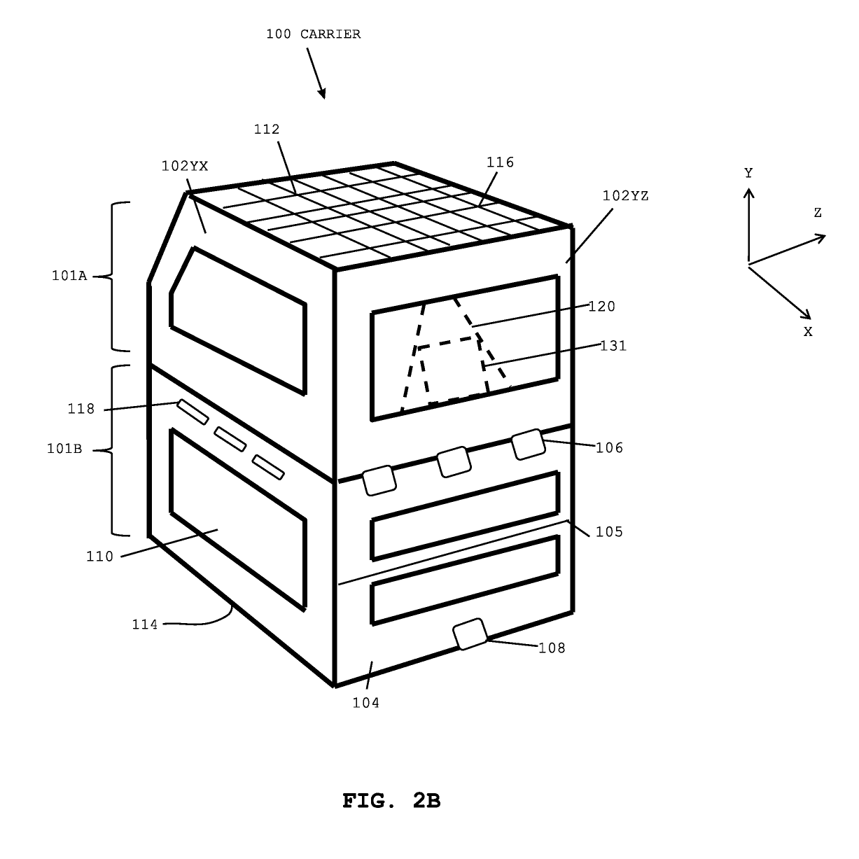

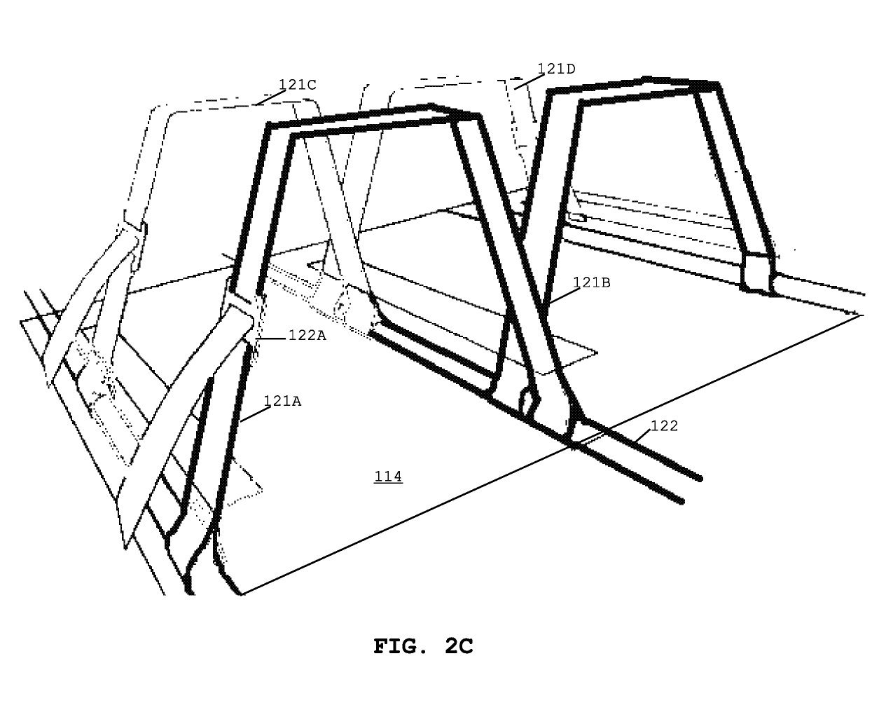

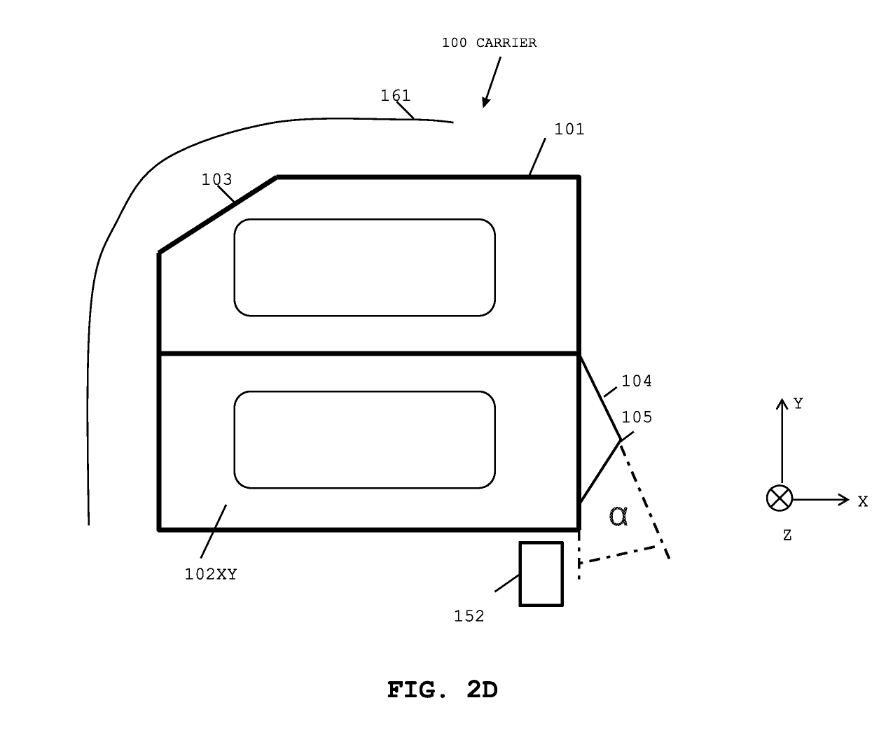

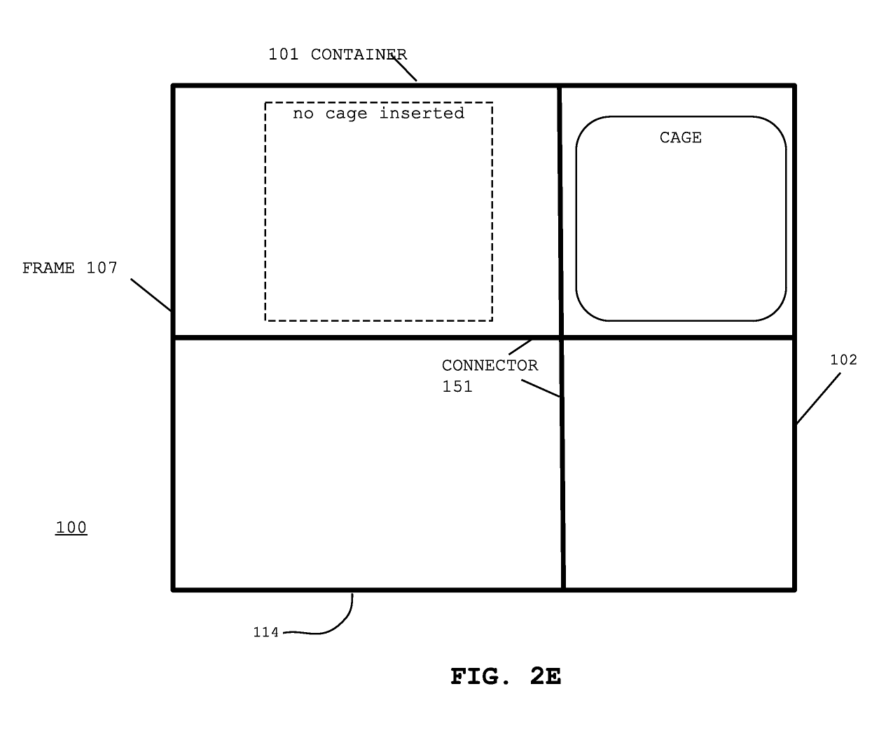

(b) Animal carrier 100 has elements for securing cage 131 (if inserted), for example, to prevent that the cage fall off during travel. It is noted that a cage is not a heavy suitcase that would be self-secured by gravity. Animal carrier 100 uses a locking mechanism that allows cages of different sizes to be inserted and to be secured. One of the ways it can be implemented is as bars, with an example being illustrated in FIGS. 2A, 2B. Instead of bars, persons of skill in the art can provide other mechanisms to secure the cage against displacement including but not limited to tie down straps, adjustable belts, nut, bolt, clips etc.

Different sized cages can be used for animals of different sizes. In the illustrative example of FIG. 1, cage 131-1 is smaller than cage 131-2. Cage 131-3 is illustrated by dashed lines to indicate that the cage has been removed.

(c) Animal carrier 100 can have two or more containers 101 that are connected to each other. In other words, animal carrier 100 can include a plurality of compartments.

The mentioned structural elements are part of animal carrier 100, but not necessarily part of the cage(s). This allows receiving cages from different manufacturers. The passenger does not have to use specialised cages.

The description now turns to details for track-connector 152 of animal carrier 100. Connector 152 is equipped with a male part which can be removably inserted into the female part of the floor-tracks 162 (illustrated in cross-section). This allows the carrier to be connected to floor-tracks (or support rails) in aircraft. The structural elements are related to the carrier, not to the cabin. This allows standardization: the connection can be similar to the connection of seat 171 to passenger cabin 161, as indicated by track-connector 153. Cabin 161 does not have to be modified. In the example of FIG. 1, seat 171 and animal carrier 100 are connected to passenger cabin 161 by floor-tracks 162 of the same type. In some embodiments, the male parts are on a slider which would enable them to be restrained at a predetermined width. This would enable the carrier 100 to be attached on the floor tracks 162 with different width. In other words the width of male part could be extended or decreased depending upon the width of the track. It is to be noted that the width of track would depend upon the size of the vehicle. For example, the tracks on a wide body aircraft would be wider than the tracks on a narrow body aircraft.

Having provided an overview, the description of animal carrier 100 continues with details.

FIG. 2A illustrates a perspective view of animal carrier 100. A coordinate system (with X, Y, Z directions) is given for convenience of explanation. Also, a coordinate system used in an aircraft can be used. The Z-direction would correspond to the flight direction. For example, the aircraft has 4 seats in a row (seat 1A aircraft window left, 1B aisle, 1C aisle and 1D aircraft window right). Seat 1B and the aisle are shown. Animal carrier 100 is located behind instead of (left side) seats 2A and 2B. Looking from the aisle, there is a Y-Z-plane in that carrier 100 has side-wall 102YZ with two windows. Looking from behind carrier (in flight direction), carrier has side-wall 102YX, with two windows as well. Other side-walls are not labelled. Carrier has three or more vertical side-walls 102. Collectively, the side-walls are referenced as 102.

Animal carrier 100 is designed to receive one or more cages, or to stay empty. In FIG. 2A animal carrier 100 is shown to include a body that is made of vertical side-walls 102, roof 112, and ground-plate 114 (or floor 114). In the example of FIG. 2, animal carrier 100 is shown with two compartments 101A/101B. However, animal carrier 100 may include only one compartment. The compartments can be made of the structural elements described above.

Vertical side-walls 102 are designed to form a closed structure in which the cages may be received. Vertical side-walls 102 together determine the external dimensions of animal carrier 100. The dimensions of animal carrier 100 can be adjusted depending upon its usage and the type of vehicle in which it is used. Also the dimensions can be adjusted depending upon the size of the cages. The dimensions of the cage can be varied depending upon the size of the animal. The cage can be designed to be substantially large to hold the animal properly and with proper comfort.

In traditional approaches, the cages would be located on normal seats. For example, six economy seats would be required for eight cages with (in total) eight animals of a particular size. Using the carrier would benefit the airline revenue by adding two more seats to be sold.

Further, vertical side-walls 102 can be made of plurality of light-weight materials, examples of which include, but not limited to, aluminium, light weight alloys, composite materials etc. The materials are selected such that carrier remains stable even of all cages are removed.

In some embodiments, vertical side-walls 102 are semi-sound proof and may have sound dampening materials present in them. The use of sound dampening materials reduces the intensity of the sound heard inside the carrier 100 by the animal. This is particularly helpful when carrier 100 is located inside the passenger cabin (or in a cargo compartment) of the vehicle, where the loud noises of the vehicle may frighten the animal. Also there might be occasions when an animal may make loud noises and this might irritate other passengers. The sound dampening materials also reduces the intensity of the sound originating from the animal carrier 100 and thus prevents any discomfort to the passengers travelling in the vehicle. Another advantage of using semi-sound proof side-walls is that although the sound intensity is reduced, it is still loud enough to let people outside know if the animal is in discomfort. Basically as the animal carrier 100 is not air-sealed; (there is ventilation) so it is semi-sound proof.

FIG. 2B illustrates a perspective view of animal carrier 100 with more details for the outside of the carrier. In some embodiments, at least one of the vertical side-walls 102 also includes door 104. Door 104 is hinged to carrier 100 using hinges 106 and is latched using latches 108. The presence of door 104 makes the insertion of the cages of the animals into the animal carrier 100 easier. In some embodiments, door 104 may be arranged with a folding mechanism 105, with details to be illustrated in FIG. 2D.

In another embodiment, two opposite side-walls (e.g., 102 YZ) may include hinged doors 104. Doors 104 may facilitate loading of cages containing animals from two sides of carrier 100.

Further, the vertical side-walls 102 may include window panes 110. In the example of FIGS. 2A/2B, side-walls 102YZ and 102YX of compartment 101A each have at least one window pane; side wall 102YX of compartment 102B has one window; and side wall 102YZ of compartment has two windows. Window panes 110 enable the passenger (or crew member) to visually monitor the animal inside carrier 100. Window panes 110 can be made of a plurality of materials, examples of which include, but not limited to glass in its various forms and various kinds of plastics.

In some embodiments, the window panes are made from plexiglass or acrylic. In another embodiment, especially when used in an aircraft, the window panes may be made from a material approved by applicable authorities, as explained before.

In some embodiments, the window panes may be made of tinted glass. Further, the glass may be such that it may only be one way tinted, such that the animal cannot see outside the animal carrier 100, but a person on the outside can look at the caged animals inside. This is particularly useful so as to ensure that the animal does not get frightened or irritated due to the happenings and disturbances occurring outside the animal carrier 100.

The roof 112 and the ground-plate 114 further define the body of animal carrier 100. In some embodiments, the ground-plate 114 may have meshed structure which may allow for effective air circulation. Roof 112 may also include a meshed structure. Meshed structure 116 is illustrated symbolic, and the person of skill in the art can select a suitable mesh size.

Also, carrier 100 can have a ventilation system to allow for circulation of air. To facilitate ventilation, flow vents can be located all over the body (side-walls) of the animal carrier 100. FIG. 2B illustrates flow-vents 118 on side-wall 102YX of compartment 101B, but flow-vents can also be provided elsewhere.

In another embodiment, carrier 100 might not have flow vents as well as the mesh structure. It might be an air sealed configuration except for the two openings; one being inlet air vent whereby the fresh air is sucked into the carrier and the other being the exhaust air vent which pushes the used air out of the carrier. In this scenario the air would pass through a filter (a combination of HEPA and carbon filter) before it is released into the cabin. HEPA is the high efficiency particulate filter to eliminate the micro particles while the carbon filter helps eliminate odors. The position of the inlet air vent is dependent on the position of the ventilation supply existing in the cabin. Typically, in an aircraft it is just below the overhead bin; in that case the inlet air vent will be on the top and the exhaust below. If the ventilation supply is located below, the inlet air vent will be on the bottom and the exhaust on the top.

In some embodiments, the ventilation system may include at least one fan for facilitating air flow. The fan may be located anywhere, either outside the body of the animal carrier 100 or inside the body of the animal carrier 100. For example, the fan may be located on the roof 112, on the ground-plate 114, or on the vertical side-walls 102. In case of multiple fans, the fans can be configured to work concurrently in a redundancy scheme such that if one of the fans malfunction, the other fans are still working and as such the ventilation in the animal carrier 100 does not suffer. In some embodiments, the number of fans in the animal carrier 100 is four.

In another embodiment, the ventilation system of the animal carrier 100 can be attached to the air supply system (of the vehicle). This is especially relevant in case of an aircraft where the passenger cabin has a separate emergency oxygen system that is deployed when the cabin pressure decreases and the ventilation system of the animal carrier 100 has direct access to this oxygen supply.

In compartment 101A, FIG. 2B illustrates cage 131 (dashed line) that is secured inside the compartment by a securing mechanism 120 (also dashed line). Details for securing mechanism will be provided in connection with FIG. 2C.

FIG. 2C illustrates details for the securing mechanism. Inside animal carrier 100, a securing mechanism is provided for securing the cages placed inside the animal carrier 100. The securing of the cages can be done in a multiple number of ways, examples of which include, but are not limited to belts, nuts, bolts, cable ties, hooks, clamps and the like. In some embodiments, the securing of the cages may be done by use of tension bars. A plurality of tension bars is present inside the animal carrier 100, and the tension bars have an adjustment mechanism enabling securing cages of different dimensions. As mentioned above, tension bars could be replaced by other mechanism.

FIG. 2C illustrates securing mechanism in an alternative embodiment with belts 121 (instead of tension bars). In the example, there are belts 121A and 121C for securing a first cage (left side, not illustrated), and belts 121B and 121 D securing a second cage (right side, not illustrated). Although the belts in the foreground (121A, 121B) are illustrated bold, all belts can be implemented similarly. The belts can have adjustable connectors (illustrated as connector 122A at belt 121A), or can be of elastic material (so that a connector is not required).

FIG. 2D illustrates a side view of animal carrier 100. A least one top side 103 of container 101 has the shape of a trapezoid to accommodate the rounding of the passenger cabin 161. This is especially useful for an aircraft. The animal carrier 100 could be implemented as a carrier for the left side seats (2A and 2B, as in FIG. 2D) or as a carrier for the right side.

FIG. 2D also illustrates a further aspect. At least one side-wall has door 104 that, if closed, is positioned in parallel to second connector 152 (i.e., along the Z-axis) for animal carrier 100 mounted on the floor-tracks 162 (FIG. 2A). Door 104 is therefor also in parallel to the floor-tracks and to the aisle. This feature is a security feature: opening door 104 completely could be dangerous for passenger and flight attendants walking along the aisle. So opening is limited. Further, even if a person accidently hits the door, the door cannot be separated from the container preventing the animal from escaping.

FIG. 2D illustrates carrier 100 placed instead of seats A (aircraft window) and B (aisle), but carrier 100 can be implemented such that carrier can be turned by 180 degrees (Z-direction). In such case, connector 152 can be a bi-directional connector, a connector that does not differentiate the direction.

As previously mentioned, door 104 can be arranged with a folding mechanism 105 (so that the swing-out a of door 104 between opened and closed positions is limited to 20 degree to the plumb line (i.e., Y-axis). Mechanism 105 separates door into two portions. In other words, carrier 100 has a bifold aisle door to accommodate a 20 degree aisle swing out. The arrangement could also be used for windows.

In some embodiments, door 104 may be a removable lid which could be removably attached to the body of the carrier 100. This is useful for aircrafts where limited space is available. The removable lid could be on any of the vertical walls which have no immediate proximity to the surrounding seats. This provides extra space for easy loading and unloading of the cages.

FIG. 2E illustrates a side view of animal carrier 100 with a focus on frame 107. Animal carrier 100 comprises container 101 (having vertical side-walls 102 and ground-plate 114) and frame 107 (that holds side-walls 102 and ground plate 114). Frame 107 is moulded from a composite material. Frame 107 may be moulded as a single piece, thus providing further stability at reduced usage of material. Connector 151 inside container 101 (between vertical side-walls 102) can be implemented together with frame 107 so that frame 107 and connector 151 are moulded as a single piece. The same principle applies to ground-plate 114 that can also be moulded as part of frame 107. In this case, vertical side-walls 102, ground-plate 114 and frame 107 form a single piece. First connector 151 can be made of structural elements that keep vertical side-walls 102 positioned even if no cage has been inserted. In other words, the elements that keep the cage(s) in place (such as boards, bar etc.) can have the further function to provide stability for container 101. In another embodiment, the frame may be constructed from composite panels or aluminium. Composite panels may be glued together using resin. If required, additional support using angles and profile to hold the composite panels or aluminium panels together may be further strengthened using screws, rivets. In another embodiment, the frame may be constructed from aluminium framing made of aluminium tubes which can form the base of the carrier and then it could be covered by plastic, aluminium panels or composite panels.

The description continues with further aspects. Animal carrier 100 can also include monitoring sensors for monitoring the animal. The sensors can be communicatively coupled to a monitoring system. The sensors can monitor ambient conditions (e.g., temperature in the carrier, temperature of the animal, humidity, noise, vibrations, oxygen), as well as take pictures or videos etc. The sensor system can include one or more client devices to be operated by the passenger (or by other person such as a crew member who is in charge of the animal). The client device can be includes a display screen on which multiple data points from a plurality of sensors can be displayed for monitoring the status inside animal carrier 100. The client device can be a mobile device that is commercially available (e.g., a so-called Smart Phone).

The plurality of sensors may be located inside the enclosure of the animal carrier 100. The plurality of sensors can enable monitoring of air circulation and ventilation in the animal carrier 100. Additional sensors may be also present to monitor temperature and humidity inside the animal carrier 100. The display screen can be coupled to the plurality of sensors and displays the readings captured by the plurality of sensors. The monitoring system can be further configured to raise warning alarms if it detects any malfunctioning of the animal carrier 100. In some embodiments, the warning alarm can be one of an audio alarm, a video alarm and a combination of both.

The sensors are related to carrier 100, but not necessarily to the cages. This is advantageous in view of simplicity of operation.

Furthermore, a power supply system may also be present in the animal carrier 100 for supplying power. The power supply system provides adequate power for running the ventilation system, the sensors of the monitoring system and other apparatus in the animal carrier 100. In some embodiments, the power supply system of the animal carrier 100 may be hooked into the power system of the vehicle. The power supply system may be a portable power source like a battery etc.

Carrier 100 is shown in FIG. 2A, 2B to include two or more compartments stacked in a row over the other. The compartments may be stacked over each other and fastened via a fastening means. The stacking of compartments over each other may enable saving space and also leads to utilization of less power. In some embodiments, the two compartments may be stacked in a row over the other. It should be appreciated that the animal carrier may just include one compartment or even more than two compartments as per the size of the cages (and animals) being transported.

The size of carrier 100 may be varied, depending upon the vehicle in which it is being installed and also on the size of the cages being transported in it. As such both small as well as large animals can be transported in the animal carrier 100 at the same time. In some embodiments, the animal carrier 100 is also designed to carry cages containing animals, wherein cage and animal(s) together weight more than 10 kilograms.

Carrier 100 can include internal lighting configured to illuminate the carrier 100 internally. This is useful, especially during long journeys when long periods of continuous darkness may cause anxiety in the animal and creates uneasiness in them. Also the lighting will aid in loading and unloading of the cages as well as help a camera to capture picture or video. The camera feature is described below.

Carrier 100 may also include a camera mounted on the enclosed body. The camera can monitor the conditions of the animal and display them on a display device located in the vehicle. The feed from the camera may also be broadcasted to a device located outside the vehicle for example to a computing device of the animal owner or a caretaker such as the smart phone as mentioned before.

Carrier 100 can include a vibration dampening system. The vibration dampers may include, but are not limited to, springs, rubber paddings and the like. The vibration dampers can protect the animal from the jerks received in the vehicle during transportation and help in ensuring a comfortable journey for the animal.

The electrical and mechanical equipment may be subjected to the DO160 Environmental Conditions and Test Procedures for Airborne Equipment which is a standard for the environmental testing of avionics hardware. Some of the environmental testing are external, internal mechanical or electrical load, EMC, shock and vibration, but not only limited to example mentioned before.

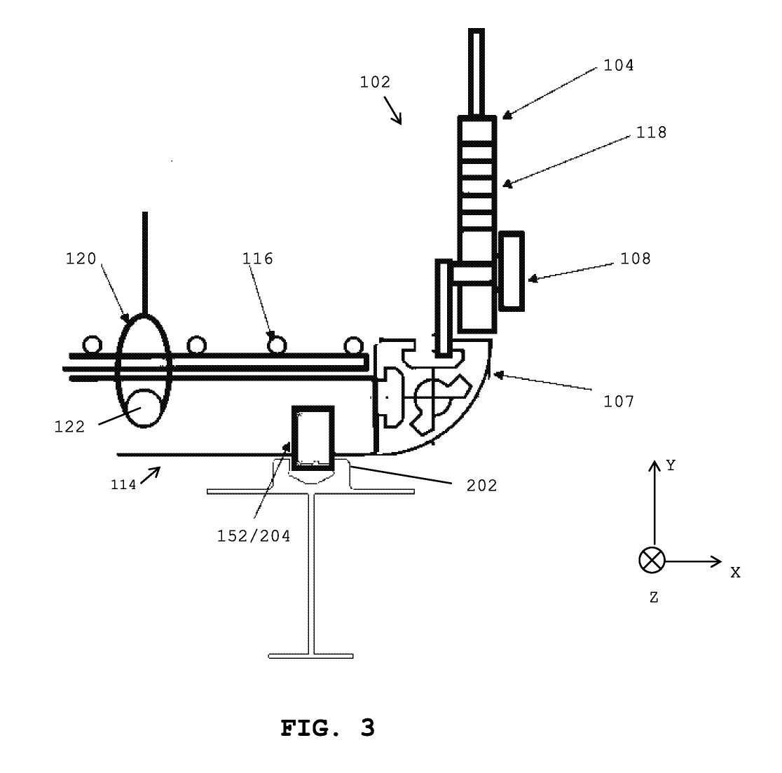

FIG. 3 illustrates—in cross-section—a partial view of the animal carrier mounted to floor-tracks 162 of an aircraft. A coordinate system (with X, Y, Z directions) is given for convenience of explanation. FIG. 3 illustrates some aspects, such as connector 152, embodiments of side walls 102, and of ground-plate 114.

As explained above (FIG. 1), connector 152 (or attachment means) are connected the container of the animal carrier to the vehicle. Connector 152 is configured to removably attach the animal carrier 100 to of inside the passenger cabin of the vehicle.

In an embodiment, connector 152 can enable the attachment of the animal carrier 100 to the floor-tracks 162 of the vehicle, the floor-track 162 being a mounting structure in the vehicle (on which a seat can usually be removably attached). As illustrated in FIG. 3, connector 152 includes an attachment/pin 204 (or, male part), in form of an extended portion of animal carrier 100. The attachment/pin 204 may engaged with a receiving member 202 (or groove) on the floor-tracks 162, thereby completing the attachment of the animal carrier 100 to the vehicle. This attachment helps to secure the animal carrier 100 against the gravitational-forces thus keeping it stabilised and secure against displacement of any sort which may be hazardous to the safety of fellow passengers. The attachment may be further reinforced with use of screws or nuts or other such fastening means.

In some embodiments, the animal carrier includes a securing means located on the top side connecting to the frame of the vehicle and thereby effectively keeping it stabilised against the displacement and be a hazard for the passengers.

Person of skill in the art can introduce further modifications. For example, connector 152 to the floor-tracks could be replaced by a mechanism to support carrier at the ceiling of the vehicle. This is similar to supporting seats in some trains. In this embodiment the animal carrier 100 would rest above the floor instead of on the floor tracks on the ground.

In some embodiments Pin 204 may be fixed. In some embodiment it can be slidable along the tracks (Z-direction), but if engaged with groove 202, movement into the X or Y direction is not possible. If the Pin 204 is on the slider mounted on the ground plate 114 along the tracks its width can be adjusted depending on the width of the tracks. It should be appreciated that different attachment means may also be used to provide attachment of carrier 100 to a vehicle. Examples for fittings between seat and other equipment to aircraft cabin are known in the art, for example, in U.S. Pat. No. 7,021,596B2 or in U.S. Pat. No. 5,975,822A, which are both incorporated by reference in their entirety.

FIG. 3 further illustrates some aspects of carrier 100. Vertical side-walls 102 are illustrated with flow vents 118 (cf. FIG. 2B). The walls can be implemented as door 104 with latches 108 (shown dosed).

FIG. 3 further illustrates that ground-plate 114 can be implemented in combination with meshed structure 116 (or being a meshed structure). The structure can be implemented with a wire mesh, or otherwise. FIG. 3 illustrates wires in cross-section. Also, frame 107 can be made from extruded aluminium.

Also, tension mechanism 120 is illustrated as attached to bar 122 (cf. FIG. 2C) that is connected, for example, to ground Plate 114.

The following is a discussion regarding the selection of the materials used for animal carrier 100. Composite materials are materials made from two or more constituent materials in combination to produce a material with characteristics different from the individual components.

For animal carrier 100, there are several constitutive materials available, for example, to be explained in general terms:

Epoxy is a polymer, being flammable in principle, some epoxy with improved fire resistance could be used. Further materials can be resin, adhesive, coating, fibre, and moulding compounds could be used.

For the moulding compounds, fire resistant thermoplastic polymers are suitable, such as polyetherimide.

Also, thermosets can be used as thermoset lower overall cost and offer the ability to use existing processing machinery and technology.

More particularly, examples for materials that are commercially available include the following:

(a) There is a carbon/epoxy unidirectional prepreg called “EP 137 UD” available from Gurti Holding AG, Switzerland. This product doesn't require a phenolic ply since the epoxy formulation has low FST properties.

(b) Gurit also provides modified cyanate ester resin prepregs for ventilation and environmental control system (ECS) ducting. Performance requirements for ducts are even more stringent than those for exposed interior components (of aircraft) Phenolic/glass prepregs that are cured in an autoclave process (expensive to manufacture) can be replaced with Gurit's nonvolatile emitting PN900 low-FST cyanate ester resin system matrix. This material has a cost-saving production processes. Vacuum-bag curing can be used. Also, the fact that free phenol and formaldehyde are no longer emitted during manufacturing makes PN900 an advantageous choice.

Material for lightweight floor panels is available as GILLFLOOR 4809, which features unidirectional carbon fiber-reinforced epoxy facings and a KEVLAR honeycomb core. GILLFLOR is commercially available from Goodrich (Uniontown, Ohio) U.S.A. KEVLAR N636 core could also be used which is a high-performance honeycomb that can offer weight savings over NOMEX.

Looking at the embodiments introduced above:

Frame 107 can be made of composite materials such as thermoplastics, fibre reinforced polymer, carbon fibre. Fibre glass, honeycomb panels or others.

Windows 110 can be made of thermoplastic resins, for example from thermoformed polyetherketoneketone (PEKK) plastic sheets, similar to the window shade panels that slide down to cover aircraft windows. Windows 110 can also be made of acrylics (PMMA, available e.g. as PLEXIGLAS) or polycarbonate (PC, LEXAN, MAKROLON) materials. Some of these materials (e.g., PLEXIGLAS) are transparent or translucent. This provides visibility of the animal allows for visual communication between the animal and its owner.

Ground-plate 114 can be made of GILLFLOOR or any other kind of composite.

Hinges 106 and Latches 108 are made up of aerospace grade metal. The hinges and latches could be load rated for its purpose to withstand a certain amount of force.

The latches on the door when the door is a removable lid are designed in such a way that when it is latched on to the animal carrier that at least a minimum of two latches would be used to secure the door on the carrier 100. In case if one of the latches fail the other will be able to hold the door against the forces that the door doesn't fall off the animal carrier 100.

Optionally, further stability to the animal carrier can be provided through the floor-tracks connector. The floor-tracks are attached to the cabin and can not move. Further the floor-tracks are designed to support seats including passengers. Therefore the tracks can forward mechanical strength through the connector (cf. FIG. 3, 202/204) to the carrier itself. In such an embodiment, the stability of the tracks could be used to keep the carrier in such a shape that the carrier remains stable.

### REFERENCES

| | |
|---|---|
| 100 animal carrier | 118 flow vents |
| 101 container | 120 tension bar, 121 belts, 122 bar |
| 102 vertical side-walls | 131 cage |
| 103 top side of the container | 141 animal |
| 104 door | 151 cage connector |
| 105 folding mechanism | 152 track connector |
| 106 hinges | 153 track connector |
| 107 frame | 161 passenger cabin |
| 108 latches | 162 floor tracks |
| 110 window panes | 202 groove, 204 male part |
| 112 roof | 116 meshed structure |
| 114 ground-plate | |

1. An animal carrier (100), comprising:
a container (101) having vertical side-walls (102), a roof (112), a ground-plate (114), and a frame (107) which holds the vertical side-walls (102) and the ground plate (114); wherein the frame (107) is moulded from an aluminium and/or composite material and/or low flammability thermoplastic;
a first connector (151) positioned inside the container (101) between the vertical side-walls (102), the first connector (151) adapted to receive at least one cage (131) for holding an animal (141); and
a second connector (152) positioned outside the container (101) is attached to the ground-plate (114), the second connector (152) adapted to be connected to floor-tracks (162) in a passenger cabin (161) of a vehicle so that the container (101) is secured against displacement.

2. The animal carrier (100) according to claim 1, wherein the frame (107) is moulded as a single piece.

3. The animal carrier (100) according to claim 1, wherein the vertical sidewalls (102), the ground-plate (104), and the roof (112) are made from composite and/or aluminium panels, wherein the panels are assembled as part of the frame (107), such that the vertical side-walls (102), the ground-plate (104), the roof (112), and the frame (107) form a single piece.

4. The animal carrier (100) according to claim 1, wherein the first connector (151) is made of structural elements that keep the vertical side-walls (102) positioned even if no cage has been inserted.

5. The animal carrier (100) according to claim 1, wherein at least one side-wall of the vertical side-walls (102) has a door (104) which is hinged.

6. The animal carrier (100) according to claim 1, wherein the vehicle is an aircraft.

7. The animal carrier (100) according to claim 1, wherein at least one side-wall of the vertical side-wall (102) has a door (104) such that, if closed, is positioned in parallel to the second connector (152) so that the door is in parallel to the floor-tracks (162).

8. The animal carrier (100) according to claim 1, wherein at least one top side (103) of the container (101) has the shape of a trapezoid to accommodate the rounding of the passenger cabin.

9. The animal carrier (100) according to claim 1, wherein mechanical support strength is provided through the connector (152) from the floor-tracks (162) of the passenger cabin (161).

10. The animal carrier (100) according to claim 9, wherein the animal carrier is implemented as a foldable carrier that receives mechanical stability after being mounted on the floor-tracks (162).

11. The animal carrier (100) according to claim 1, further comprising electrical and hardware components, wherein the components are tested for Environmental Conditions and Test Procedures for Airborne Equipment.

12. The animal carrier (100) according to claim 1, wherein the container (101) includes an exhaust air filter for removing odour, dander and other particulate matter before being released to the passenger cabin.

13. The animal carrier (100) according to claim 1, wherein at least one side-wall of the vertical side-walls (102) has a door (104) which is completely detachable.

14. The animal carrier (100) according to claim 1, wherein the at least one Cage could be secured by a variety of means including but not limited to tension bars, belts, nuts, bolts, cable ties, hooks, tie-down straps, and clamps.

15. The animal carrier (100) according to claim 7, wherein the second connector (152) can be connected to the tracks in the passenger cabin (161) in two directions.
